(19) United States
(12) Patent Application Publication
(10) Pub. No.: US 2010/0238361 A1
(43) Pub. Date: Sep. 23, 2010

(54) SOUND SIGNAL PROCESSING CIRCUIT

(75) Inventors: Tsutomu Tanaka, Gunma-ken (JP); Hiroshi Matsui, Kanagawa-ken (JP)

Correspondence Address: OSHA LIANG L.L.P., TWO HOUSTON CENTER, 909 FANNIN, SUITE 3500, HOUSTON, TX, 77010, US

(73) Assignee: Sanyo Electric Co., Ltd., Moriguchi-shi, Osaka (JP)

(21) Appl. No.: 12/280,177

(22) PCT Filed: Apr. 4, 2007
(86) PCT No.: PCT/JP2007/057556

§ 371 Date: Aug. 21, 2008

(30) Foreign Application Priority Data
Apr. 5, 2006 (JP) 2006-103813

(51) Int. Cl. H04N 5/60

(52) U.S. Cl. 348/738; 348/E05.122

(57) ABSTRACT

A first band-pass filter extracts, from a first sound intermediate frequency signal, a signal having a frequency in the vicinity of a center frequency of the first sound intermediate frequency signal. Then, a mixer down converts a signal extracted by the first band-pass filter to a second sound intermediate frequency signal. A low-pass filter extracts, from the second sound intermediate frequency signal, a signal having a frequency in the vicinity of a center frequency of the second sound intermediate frequency signal or a lower frequency. With such an arrangement, FM detection can be performed preferably even if the frequency of the first sound intermediate frequency signal is deviated.

### TECHNICAL FIELD

The present invention relates to frequency conversion FM detection of a sound signal in a television signal.

### BACKGROUND ART

In various television (TV) signal systems such as NTSC, PAL, PALNM, SECAM, and so on, different frequency bands are allocated to video signals and sound signals, respectively, and FM (Frequency Modulation) is adopted as a modulation mode of sound signals.

A television signal containing a first sound intermediate frequency signal (first SIF) is processed by a first band-pass filter to extract the first sound intermediate frequency signal, and is then down converted to a second sound intermediate frequency signal (second SIF). Then, the second sound intermediate frequency signal thus obtained is processed by a second band-pass filter and is subjected to FM detection. Here, in accordance with the TV signal systems including those described above, the frequencies of sound signals are classified into five types: 4.5 MHz, 5.5 MHz, 5.74 MHz, 6.0 MHz, and 6.5 MHz, and the frequency of a local oscillator signal to be mixed with sound signals at the time of down conversion varies depending on the frequency type. Here, the second SIF signal normally has a frequency of 500 kHz, and the local oscillator frequency is set to a frequency which is deviated from that of the first SIF signal by 500 kHz. For example, a local oscillator signal of 6 MHz is mixed in the first SIF signal of 5.5 MHz, to thereby obtain the second SIF signal of 500 kHz.

The processing of sound signals is disclosed in JP11-274858A.

Here, if the frequency of the first SIF signal extracted from a TV signal is deviated from a predetermined frequency, the FM demodulation range will be restricted due to the characteristics of the second band-pass filter.

With regard to the first band-pass filter, which processes a signal having a comparatively high frequency (i.e. several MHz), it is difficult to enhance the bandpass selectivity and therefore a band-pass filter having characteristics of a certain degree of broad selectivity is adopted. While it is technically possible to increase this selectivity by adopting a highly precise circuit taking no consideration of the number of elements and the power consumption, such a circuit is not practical in consideration of costs and so on.

On the other hand, with regard to the second band-pass filter for a signal whose frequency has been converted to 500 kHz, the band limitation width can be made small even when the selectivity of the second band-pass filter is the same as that of the first band-pass filter. Accordingly, interference components such as video signals which are not necessary for FM demodulation can be removed effectively. As such, the band limitation by the second band-pass filter is essential.

However, if the frequency of the first SIF signal which should be 5.5 MHz is 5.7 MHz, for example, the frequency of the second SIF signal would be 300 kHz, making it impossible to achieve sufficient FM demodulation of the second SIF signal.

### DISCLOSURE OF THE INVENTION

The present invention is characterized in including a first band-pass filter for extracting, from a first sound intermediate frequency signal, a signal having a frequency in the vicinity of a center frequency of the first sound intermediate frequency signal; a mixer for down converting a signal extracted by the first band-pass filter to a second sound intermediate frequency signal; a low-pass filter for extracting, from the second sound intermediate frequency signal, a signal having a frequency in the vicinity of a center frequency of the second sound intermediate frequency signal or a lower frequency; and an FM detector for subjecting a signal extracted by the low-pass filter to FM detection.

Further, it is preferable that a second band-pass filter for extracting, from the second sound intermediate frequency signal, a signal having a frequency in the vicinity of a center frequency of the second sound intermediate frequency signal, is further provided and either an output from the second band-pass filter or an output from the low-pass filter is supplied to the FM detector in a switchable manner.

Also, it is preferable that a frequency detector for detecting a frequency of the first sound intermediate frequency signal is further provided and either an output from the second band-pass filter or an output from the low-pass filter is supplied to the FM detector in a switchable manner based on a result of detection by the frequency detector.

Moreover, it is preferable that a DC detector for detecting a DC component in the output of the FM detector is further provided and either an output from the second band-pass filter or an output from the low-pass filter is supplied to the FM detector in a switchable manner based on a result of detection by the DC detector.

According to the present invention, by adopting a low-pass filter as a filter for a second sound intermediate frequency signal which affects the band limitation characteristics of a sound signal, the allowable deviation range of the sound signal frequency can be expanded to a demodulation limit of an FM detector while keeping interference components, such as video signals which are not necessary for FM demodulation, removed.

### BRIEF DESCRIPTION OF THE DRAWINGS

These and other objects of the invention will be explained in the description below, in connection with the accompanying drawings, in which:

FIG. 1 is a view showing a structure of an embodiment of the present invention;

FIG. 2 is a view showing a structure of another embodiment of the present invention;

FIG. 3 is a view showing a structure of yet another embodiment of the present invention;

FIG. 4 is a view for explaining the principle of FM detection; and

FIG. 5 is a view showing a structure of PLL.

### BEST MODE FOR CARRYING OUT THE INVENTION

Preferred embodiments of the present invention will be described with reference to the drawings.

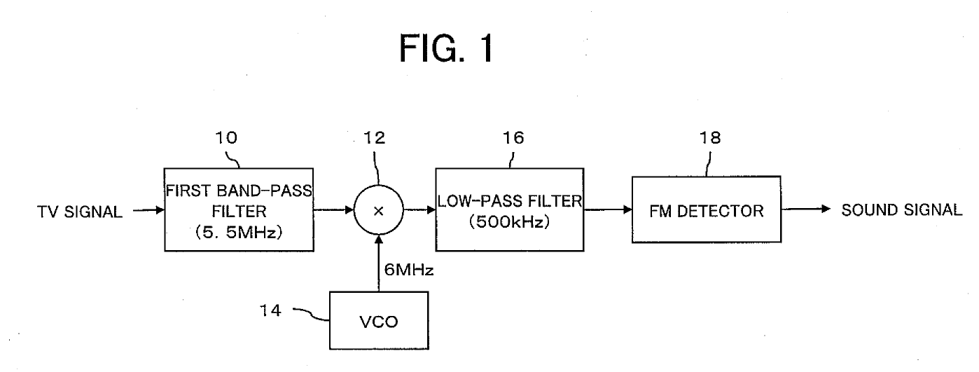

FIG. 1 is a block diagram of a sound signal processing circuit according to an embodiment of the present invention. A TV signal is processed by a first band-pass filter 10. The first band-pass filter 10, whose center frequency is 5.5 MHz, for example, is capable of outputting a first SIF signal in the frequency band of 5.5 MHz. The output of the first band-pass filter 10 is input to a mixer 12. A local oscillator signal having a frequency of 6 MHz, for example, is supplied to the mixer 12 from a voltage controlled oscillator (VCO) 14. Accordingly, in this mixer 12, the first SIF signal is down converted, so that a second SIF signal having a frequency of 500 kHz, for example, is obtained.

The second SIF signal obtained by the mixer 12 is supplied to a low-pass filter 16. This low-pass filter 16 limits frequency components exceeding 500 kHz.

The output of the low-pass filter 16 is supplied to a FM detector 18 where the input signal is subjected to FM detection, so that a sound signal is obtained.

For example, the low-pass filter 16 has characteristics that allow all the signals having a frequency of 500 kHz or lower to pass, so that if the frequency of the second SIF signal is 500 kHz, such a signal can be extracted without being attenuated. On the other hand, a video signal, which exists in the frequency band of 1 MHz or higher in the output of the mixer 12, can be reliably removed by the low-pass filter 16.

Here, with regard to TV signals, in the NTSC system, the video signal bandwidth is 4.2 MHz or less, and the sound signal bandwidth is at 4.5 MHz with FM modulation being adopted, and in the PAL system, the video signal bandwidth is 5 MHz or less, and the sound signal bandwidth is at 5.5 to 6 MHz with FM modulation is adopted, with respect to the picture carrier frequency fp serving as a reference.

Accordingly, even when the low-pass filter 16 is adopted as a filter for extracting the second SIF signal as in the present embodiment, a video signal can be removed. Further, even if the frequency of the first SIF signal which has been expected to be 5.5 MHz is actually deviated to the frequency of 5.7 MHz, resulting in the frequency of the second SIF signal being 300 kHz, for example, the second SIF signal will not be band-limited. Consequently, it is possible to utilize the demodulation capability of the FM detector 18 to the utmost limit for performing demodulation processing.

As described above, according to the present embodiment, with the use of the low-pass filter 16 as a filter concerning the second SIF signal which affects the band-limitation characteristics of a sound signal, the allowable range of deviation of the sound signal frequency can be extended to the demodulation limit of the FM detector, while keeping interference components such as video signals which are not necessary for FM demodulation removed.

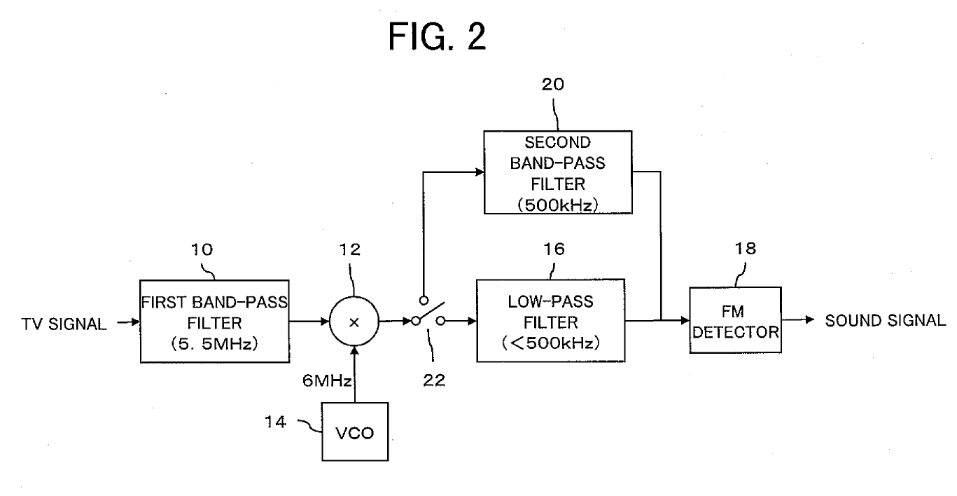

FIG. 2 shows a structure of the present invention according to another embodiment. In this embodiment, a band-pass filter 20 having an output connected to the FM detector 18 is provided in parallel to the low-pass filter 16. The second SIF signal output from the mixer 12 is selectively supplied either to the band-pass filter 20 or to the low-pass filter 16 by means of a switch 22. As such, the band-pass filter 20 can be selected as required, in place of the low-pass filter 16. For example, when the frequency of the first SIF signal is not deviated from the expected frequency, the interferences can be removed more reliably by adopting the band-pass filter 20.

Accordingly, in such a case, it is preferable to select the band-pass filter 20 with the switch 22.

Further, a 2-carrier system for sound signals is adopted in some areas. In this system, two types of sound signals at frequencies of 5.74 MHz and 5.5 MHz are adopted. Accordingly, in order to select a sound signal at 5.5 MHz in such areas, it is necessary to remove signals in the frequency band of 260 kHz from the output of the mixer 12, which further makes it necessary to select the band-pass filter 20 whose center frequency is 500 kHz by using the switch 22.

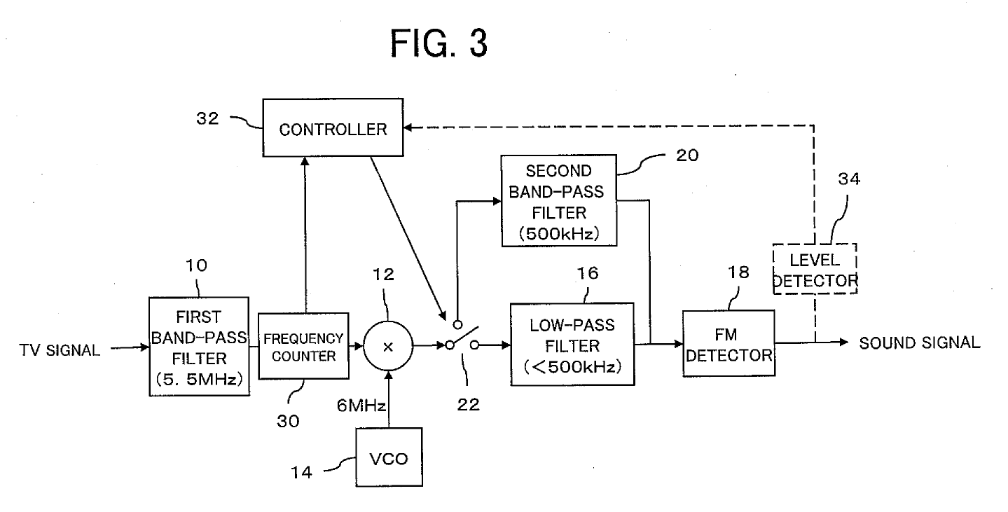

FIG. 3 shows a structure of the present invention according to still another embodiment. In this embodiment, a frequency counter 30 for detecting the frequency of the first SIF signal output from the first band-pass filter 10 is further provided. The output of the frequency counter 30 is supplied to a controller 32 which then controls switching to be performed by the switch 22. More specifically, the frequency of the first SIF signal is detected by the frequency counter 30, and the low-pass filter 16 is selected when the detected frequency is deviated from the expected frequency and the second band-pass filter 20 is selected at normal times.

Further, it is also preferable to provide a level detector 34 for detecting the DC level of the output from the FM detector 18, as shown by a broken line in FIG. 3. The DC level of the FM detector 18 is high when the frequency of a signal to be subjected to FM detection is deviated from the expected frequency. Accordingly, it is possible to configure the structure such that the switch 22 selects the low-pass filter 16 when the detected DC level is high.

Further, it is also possible to provide both the frequency counter 30 and the level detector 34 such that the low-pass filter 16 is selected when a significant amount of deviation of the frequency of a sound signal is detected by at least one of the frequency counter 30 and the level detector 34.

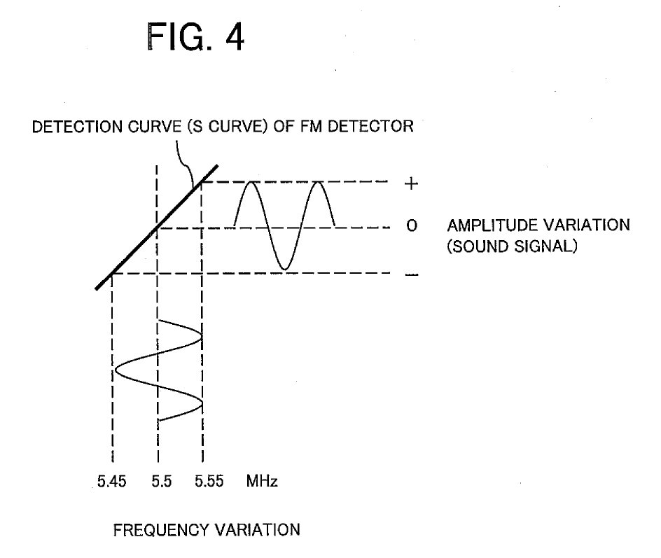

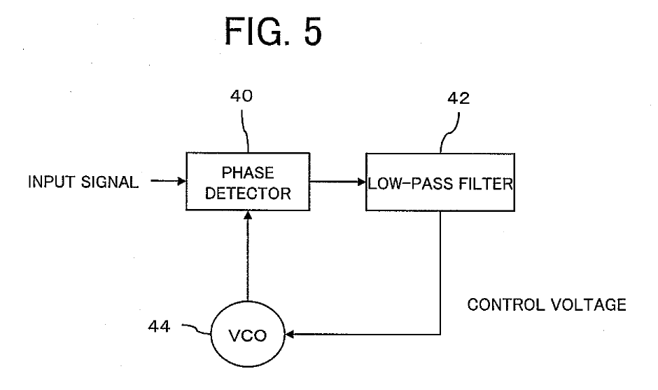

Here, in a FM modulated wave, a variation in amplitude of a sound signal has been transformed into a variation in frequency. In the FM detector, as shown in FIG. 4, the frequency variation is transformed in amplitude in accordance with the detection curve (S curve) of the FM detector, thereby obtaining a sound signal. FIG. 5 shows a PLL (Phase Locked Loop) FM detector as one example of the FM detector 18. An input signal (the second SIF signal) is input to a phase comparator 40, and a signal concerning a phase difference is input to a voltage controlled oscillator (VCO) 44 as a DC control voltage through a low-pass filter 42. As such, the voltage controlled oscillator 44 is controlled to supply a signal having the same phase as that of the input signal. Then, in a state where the PLL is locked with respect to the carrier frequency of FM demodulation, a phase difference of the input signal with respect to the output of the PLL is detected, to thereby achieve FM detection. Such an FM detector 18 is suitable for processing the second SIF signal which has been processed by the low-pass filter 16 as in the present embodiment.

Further, according to the present embodiment, the frequency range which can be traced by the voltage controlled oscillator 44 is expanded, thereby increasing the detection range. As such, FM detection can be achieved even when the frequency deviation of the first SIF signal is relatively large.

1. A sound signal processing circuit, comprising:
a first band-pass filter for extracting, from a first sound intermediate frequency signal, a signal having a frequency in the vicinity of a center frequency of the first sound intermediate frequency signal;
a mixer for down converting a signal extracted by the first band-pass filter to a second sound intermediate frequency signal;
a low-pass filter for extracting, from the second sound intermediate frequency signal, a signal having a frequency in the vicinity of a center frequency of the second sound intermediate frequency signal or a lower frequency; and
an FM detector for subjecting a signal extracted by the low-pass filter to FM detection.

2. The sound signal processing circuit according to claim 1, further comprising:
a second band-pass filter for extracting, from the second sound intermediate frequency signal, a signal having a frequency in the vicinity of a center frequency of the second sound intermediate frequency signal,
wherein
either an output from the second band-pass filter or an output from the low-pass filter is supplied to the FM detector in a switchable manner.

3. The sound signal processing circuit according to claim 2, further comprising:
a frequency detector for detecting a frequency of the first sound intermediate frequency signal,
wherein
either an output from the second band-pass filter or an output from the low-pass filter is supplied to the FM detector in a switchable manner based on a result of detection by the frequency detector.

4. The sound signal processing circuit according to claim 2 , further comprising:
a DC detector for detecting a DC component in the output of the FM detector,
wherein
either an output from the second band-pass filter or an output from the low-pass filter is supplied to the FM detector in a switchable manner based on a result of detection by the DC detector.
